(19) United States
(12) Patent Application Publication
(10) Pub. No.: US 2006/0147549 A1
(43) Pub. Date: Jul. 6, 2006

(54) Methods and compositions for reducing population of plant pathogen

(76) Inventors: Lawrence A. Grab, Dusseldorf (DE); Teresa C. Podtburg, Waconia, MN (US); Bruce E. Schmidt, St. Paul, MN (US)

Correspondence Address: MERCHANT & GOULD PC, P.O. BOX 2903, MINNEAPOLIS, MN, 55402-0903, US

(21) Appl. No.: 11/292,789

(22) Filed: Dec. 2, 2005

Related U.S. Application Data
(60) Provisional application No. 60/640,595, filed on Dec. 30, 2004.

(51) Int. Cl. A01N 59/16

(52) U.S. Cl. 424/618

(57) ABSTRACT

The present invention relates to methods for reducing the population of canker microbe (e.g., citrus canker microbe) or microbes and articles of manufacture that can be used in the method. The methods employ and the articles of manufacture include composition including metal antimicrobial agent, poly(hexamethyl biguanide), surfactant, and alcohol.

### CROSS REFERENCE TO RELATED APPLICATIONS

This application claims the benefit of U.S. Provisional Patent Application Ser. No. 60/640,595, filed Dec. 30, 2004, which application is hereby incorporated by reference in its entirety.

### FIELD OF THE INVENTION

The present invention relates to methods for reducing the population of canker microbe (e.g., citrus canker microbe) or microbes and to articles of manufacture that can be used in the method. The methods employ and the articles of manufacture include composition including metal antimicrobial agent, poly(hexamethyl biguanide), surfactant, and alcohol.

### BACKGROUND OF THE INVENTION

Citrus canker is a growing problem for citrus growers. There remains a need for effective methods and compositions for reducing the population of the microbe or microbes that cause citrus canker.

### SUMMARY OF THE INVENTION

The present invention relates to methods for reducing the population of canker microbe (e.g., citrus canker microbe) or microbes. The method can include applying to an object an antimicrobial composition. The antimicrobial composition can include a metal antimicrobial agent (e.g., silver ion) and a polymer, for example, a poly(hexamethyl biguanide), surfactant, and alcohol. The method can include applying the antimicrobial composition in amount and for time sufficient to reduce the microbial population.

The present invention relates to methods for treating plant canker. In an embodiment, the present method includes a method for treating citrus canker. The method can include applying to a citrus tree an antimicrobial composition. The antimicrobial composition can include a metal antimicrobial agent (e.g., silver ion) and a polymer, for example, a poly(hexamethyl biguanide), surfactant, and alcohol. The method can include applying the antimicrobial composition in amount and for time sufficient to reduce the microbial population.

The present invention relates to methods and compositions for reducing the population of canker microbe (e.g., citrus canker microbe). Such a composition can include a composition including metal antimicrobial agent, poly(hexamethyl biguanide), surfactant, and alcohol. The present invention relates to articles of manufacture. Such an article of manufacture can include a composition including metal antimicrobial agent, poly(hexamethyl biguanide), surfactant, and alcohol.

### DETAILED DESCRIPTION OF THE INVENTION

Definitions

As used herein, the term “microorganism” refers to any noncellular or unicellular (including colonial) organism. Microorganisms include all prokaryotes. Microorganisms include bacteria (including cyanobacteria), lichens, fungi, protozoa, virinos, viroids, viruses, phages, and some algae. As used herein, the term “microbe” is synonymous with microorganism.

As used herein, the phrase “canker microbe” refers to any microbe that causes a disorder of a plant, vegetable, or fruit known as a canker. Canker microbes include those of the family Xanthomonas. The canker microbe can be a plant canker microbe, a produce canker microbe, a tomato canker microbe, a citrus canker microbe, or the like. Suitable microbes of the family Xanthomonas include X. axonopodis (syns. X campestris, X citri), such as Xanthomonas axonopodis pv citri, X. campestris pv campestris, X. campestris pv oryzae, X. campestris pv vesicatoria, X. axonopodis pv aurantifolia, X. anonopdois pv citrumelo, and X. albilineans, and the like.

As used herein, the phrase “citrus canker microbe” refers to any microbe that causes a disorder of citrus plants or fruit known as citrus canker. Citrus canker microbes include those of the family Xanthomonas. Citrus canker microbes from the family Xanthomonas include X. axonopodis (syns. X. campestris, X citri), such as Xanthomonas axonopodis pv. citri, X. axonopodis pv aurantifolia, and the like.

As used herein, the phrase “tomato canker microbe” refers to any microbe that causes a disorder of tomato plants or fruit known as tomato canker, tomato spot, or tomato speck. Tomato canker microbes include those of the family Xanthomonas. Tomato canker microbes from the family Xanthomonas include X. campestris pv vesicatoria, and the like. Additional tomato canker microbes include Pseudomonas syringae pv tomato and Clavibacter michiganensis pv michiganensis.

As used herein, equipment used with citrus fruit and plants includes equipment used in cultivating, harvesting, storing, transporting, and processing citrus, such as tool, implement, container for collecting and transporting harvested fruit, transport vehicle, or the like. Such equipment includes truck, goat, bus, trailer, box, crate, cargo cover (e.g., tarp), bin, basket, ladder, power tool, hand tool, picking sack, clipper, clothing (e.g., hat, shoe, or glove), or the like.

As used herein, the term “produce” refers to food products such as fruits and vegetables and plants or plant-derived materials that are typically sold uncooked and, often, unpackaged, and that can sometimes be eaten raw.

As used herein, the phrase “plant product” includes any plant substance or plant-derived substance that might benefit from treatment with an antimicrobial agent or composition. Plant products include seeds, nuts, nut meats, cut flowers, plants or crops grown or stored in a greenhouse, house plants, and the like. Plant products include many animal feeds.

As used herein, the term “object” refers to a something material that can be perceived by the senses, directly and/or indirectly. Objects include a surface, including a hard surface (such as glass, ceramics, metal, natural and synthetic rock, wood, and polymeric), an elastomer or plastic, woven and non-woven substrates, a citrus processing surface, and the like. Objects also include a citrus product (and its surfaces) and a body or stream of water or a gas (e.g., an air stream) employed in citrus production or processing.

As used herein, weight percent (wt-%), percent by weight, % by weight, and the like are synonyms that refer to the concentration of a substance as the weight of that substance divided by the weight of the composition and multiplied by 100. Unless otherwise specified, the quantity of an ingredient refers to the quantity of active ingredient.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term about also encompasses amounts that differ due to different equilibrium conditions for a composition resulting from a particular initial mixture. Whether or not modified by the term “about”, the claims include equivalents to the quantities.

As used herein, a composition or combination “consisting essentially” of certain ingredients refers to a composition including those ingredients and lacking any ingredient that materially affects the basic and novel characteristics of the composition or method. The phrase “consisting essentially of” excludes from the claimed compositions and methods additional antimicrobial agents; unless such an ingredient is specifically listed after the phrase.

As used herein, a composition or combination “substantially free of” one or more ingredients refers to a composition that includes none of that ingredient or that includes only trace or incidental amounts of that ingredient. Trace or incidental amounts can include the amount of the ingredient found in another ingredient as an impurity or that is generated in a minor side reaction during formation or degradation of the compositions employed in the present method.

For the purpose of this patent application, successful microbial reduction is achieved when the microbial populations are reduced by at least about 50%, or by significantly more than is achieved by a wash with water. Larger reductions in microbial population (e.g., at least about 99% reduction) provide greater levels of protection.

As used herein, the term “sanitizer” refers to an agent that reduces the number of bacterial contaminants to safe levels as judged by public health requirements. In an embodiment, sanitizers for use in this invention will provide at least a 99.999% reduction (5-log order reduction). These reductions can be evaluated using a procedure set out in Germicidal and Detergent Sanitizing Action of Disinfectants, Official Methods of Analysis of the Association of Official Analytical Chemists, paragraph 960.09 and applicable sections, 15th Edition, 1990 (EPA Guideline 91-2). According to this reference a sanitizer should provide a 99.999% reduction (5-log order reduction) within 30 seconds at room temperature, 25±2° C., against several test organisms.

As used herein, the term “disinfectant” refers to an agent that kills all vegetative cells including most recognized pathogenic microorganisms, using the procedure described in A.O.A.C. Use Dilution Methods, Official Methods of Analysis of the Association of Official Analytical Chemists, paragraph 955.14 and applicable sections, 15th Edition, 1990 (EPA Guideline 91-2).

Differentiation of antimicrobial “-cidal” or “-static” activity, the definitions which describe the degree of efficacy, and the official laboratory protocols for measuring this efficacy are considerations for understanding the relevance of antimicrobial agents and compositions. Antimicrobial compositions can effect two kinds of microbial cell damage. The first is a lethal, irreversible action resulting in complete microbial cell destruction or incapacitation. The second type of cell damage is reversible, such that if the organism is rendered free of the agent, it can again multiply. The former is termed microbicidal and the later, microbistatic. A sanitizer and a disinfectant are, by definition, agents which provide antimicrobial or microbicidal activity. In contrast, a preservative is generally described as an inhibitor or microbistatic composition.

Reducing Population of Canker Microbe

The present invention relates to methods for reducing the population of canker microbe (e.g., citrus canker microbe) or microbes. The method includes applying to an object an antimicrobial composition. The method includes applying the antimicrobial composition in amount and for time sufficient to reduce the microbial population. The antimicrobial composition can include metal antimicrobial agent (e.g., silver ion), polymer (e.g., a poly(hexamethyl biguanide)), surfactant, and alcohol. In an embodiment, the antimicrobial composition includes carrier (e.g., water), poly(hexamethyl biguanide), silver ion (e.g. silver iodide), surfactant (e.g., Triton X-100 (octyl phenol alkoxylate n9.5) and Tectronic 1107 (alkoxylated ethylene diamine with, for example an average molecular weight of about 15,000), solvent (e.g., 1-methyl-2-pyrrolidinone), and alcohol (e.g., ethanol).

The method can include applying the antimicrobial composition to any of a variety of objects, such as a citrus tree. The method can include applying the antimicrobial composition to citrus fruit. The citrus fruit can be on the tree or can be off the tree (i.e., it can already have been picked). The method can include applying the antimicrobial composition to inanimate objects, such as equipment. The equipment can be equipment used in a citrus orchard, equipment used for transporting or processing citrus fruit, equipment used for transporting or processing citrus plant, or the like.

The present invention relates to methods for treating citrus canker. The method includes applying to a citrus tree an antimicrobial composition. The antimicrobial composition can include a metal antimicrobial agent (e.g., silver ion) and a polymer, for example, a poly(hexamethyl biguanide). The method includes applying the antimicrobial composition in amount and for time sufficient to reduce the microbial population.

The present invention relates to methods and compositions for reducing the population of canker microbe (e.g., citrus canker microbe). Such a composition includes metal antimicrobial agent and poly(hexamethyl biguanide). The composition can be for applying to an object subject to contamination with canker microbe (e.g., citrus canker microbe).

The present invention relates to articles of manufacture. Such an article of manufacture can include a composition including metal antimicrobial agent and poly(hexamethyl biguanide). Such an article of manufacture can include a sprayer configured for spraying citrus and a composition including metal antimicrobial agent and poly(hexamethyl biguanide). Suitable sprayers configured for spraying citrus include those large enough to be towed behind a truck and that, for example, use air in forming a spray from a composition in a tank or other container. Suitable sprayers include electrostatic sprayers. Such an article of manufacture can include composition including metal antimicrobial agent and poly(hexamethyl biguanide) and instructions for applying the composition to citrus. Such an article of manufacture can include composition including metal antimicrobial agent and poly(hexamethyl biguanide) and instructions for applying the composition to object subject to contamination with canker microbe (e.g., citrus canker microbe).

Any of a variety of known methods can be employed for testing for activity against a canker microbe (e.g., citrus canker microbe). For example, a composition can be tested in a laboratory test (e.g., in vitro) or a nursery. Embodiments of such methods are described in the Examples.

For example, a composition can be tested in a prevention fruit protocol. A prevention fruit protocol can employ citrus fruit (non-waxed) treated with 50 ppm sodium hypochlorite and rinsed with sterilized Milli-Q water. The method can include treating a fruit surface by spraying a solution of the test substance over the fruit surface with a spray bottle several times over one week. Infecting the fruit can be carried out by misting Xanthomonas (e.g., Xanthomonas axonopodis ATCC 49118) or a model microorganism over surface or by spot inoculation (especially to vulnerable areas). This can be followed by allowing bacteria to sit on the fruit overnight. The fruit can be treated with the test substance. The fruit can be incubated in a hood for about 2 to about 3 weeks to determine if there is growth. The fruit can be sampled after the incubation period by putting the fruit into neutralizer (bag), massaging for one minute, and plating. Controls can include fruit treated with chemicals for the first treatment period, inoculated with no follow-up treatment, and fruit untreated with chemicals but inoculated.

Washing Citrus with Anti-Citrus Canker Compositions

The present method can include methods of treating and using water-based systems for transporting, processing, and/or washing citrus. The present invention relates to methods for transporting or processing citrus using an aqueous medium to transport the citrus through, for example, one or more processing steps and environments. According to the present invention, the aqueous medium includes metal antimicrobial agent and a poly(hexamethyl biguanide). The present invention includes a method for reducing the population of microbes in aqueous streams by applying or incorporating a metal antimicrobial agent and a poly(hexamethyl biguanide) to or into the aqueous stream. Generally, the method of the invention is applicable to aqueous streams used in any number of applications such as the application of streams for the transport of citrus into the processing environment and through the various steps of processing.

In an embodiment, after picking, the present method includes transporting and/or washing citrus in a stream of an aqueous metal antimicrobial agent and poly(hexamethyl biguanide) composition. For example, an aqueous metal antimicrobial agent and poly(hexamethyl biguanide) composition can be used to support or transport the citrus from an unloading site to a storage, packing, or processing location. The method can include introducing the citrus into a flume containing an aqueous metal antimicrobial agent and poly(hexamethyl biguanide) composition.

In an embodiment, the present method includes transporting fresh citrus in and to food handling equipment used at a processing plant using a stream of an aqueous metal antimicrobial agent and poly(hexamethyl biguanide) composition. For example, the method can include transporting a food item using or in an aqueous metal antimicrobial agent and poly(hexamethyl biguanide) composition from an initial location through a series of individual processing stages to a station where the citrus is removed from the water and packed. The present invention can include recycling the aqueous metal antimicrobial agent and poly(hexamethyl biguanide) composition used for transporting or processing citrus.

In an embodiment, the present method includes cleaning (e.g., washing), cooling (e.g., in a bath), heating, cooking, or otherwise processing the citrus before packaging using an aqueous metal antimicrobial agent and poly(hexamethyl biguanide) composition. In an embodiment, the present method includes transporting and processing the citrus using the same aqueous stream. In an embodiment, the present method includes transporting the citrus in a first aqueous stream and processing the citrus in a second aqueous composition distinct from the transport stream. The present invention includes recycling the aqueous metal antimicrobial agent and poly(hexamethyl biguanide) composition employed in methods for cleaning, cooling, heating, cooking, or otherwise processing the citrus.

In an embodiment, the present invention includes reducing the population of microbes on or in the water, flume, or other transport or processing equipment employed with the citrus. The method includes contacting the water, flume, or other transport or processing equipment with metal antimicrobial agent and poly(hexamethyl biguanide) composition. In an embodiment, the present invention includes reducing or preventing the buildup of slime or biofilm on surfaces of the flume or other transport or processing equipment employed with the citrus. The method includes contacting the surfaces of the flume or other transport or processing equipment with metal antimicrobial agent and poly(hexamethyl biguanide) composition.

The present invention also includes methods for packaging citrus. In an embodiment, the present method can reduce the microbial population on citrus or packaging material before or during the packaging operation. The method includes contacting the citrus or packaging material with metal antimicrobial agent and poly(hexamethyl biguanide) composition before or during the packaging operation. In an embodiment, the present method can reduce the microbial population on packaged citrus. The method includes contacting the package of citrus with metal antimicrobial agent and poly(hexamethyl biguanide) composition.

The present method also includes transporting or processing packaged citrus using the metal antimicrobial agent and poly(hexamethyl biguanide) composition. In an embodiment, the present method includes heating, cooling, or otherwise processing packaged citrus using an aqueous metal antimicrobial agent and poly(hexamethyl biguanide) composition.

In an embodiment, the present invention includes reducing the population of microbes on citrus. The method can include contacting the citrus with metal antimicrobial agent and poly(hexamethyl biguanide) composition. Contacting can include applying the present composition to the citrus. Applying can occur at any step of the life cycle, production cycle, or marketing of the citrus. For example, the present composition can be applied to the citrus in the field, in or on any apparatus (e.g., harvester), in a transport apparatus or during transport, in a warehouse, in a processing facility, in a wholesaler, in a retail establishment (e.g., a grocer), in a home, or in a restaurant.

Once the metal antimicrobial agent and poly(hexamethyl biguanide) composition of the invention is applied to any given transport stream, the antimicrobial will be subjected to a demand resulting from microbes present in the stream as well as other organic or inorganic material present in the stream. As a general guideline, not limiting of the invention, the present invention includes the concentrations of metal antimicrobial agent and poly(hexamethyl biguanide) composition found after demand.

Embodiments of the methods of the present invention can include agitation or sonication of the use composition, particularly as a concentrate is added to water to make the use composition. In an embodiment, the present methods include water systems that have some agitation, spraying, or other mixing of the solution. The citrus can be contacted with the compositions of the invention effective to result in a reduction significantly greater than is achieved by washing with water, or at least a 50% reduction, at least a 90% reduction, or at least a 99% reduction in the resident microbial preparation.

The present methods can employ a certain minimal contact time of the composition with of citrus for occurrence of significant antimicrobial effect. The contact time can vary with concentration of the use composition, method of applying the use composition, temperature of the use composition, amount of soil on the citrus, amount of soil in the aqueous stream, number of microorganisms on the citrus, number of microorganisms in the aqueous stream, or the like. Contact time in the field can be for as long as nature allows, for example, until the next rain or heavy rain. In an embodiment, the exposure time is at least about 5 to about 60 seconds.

Electrostatic Sprayers and Spraying

In another alternative embodiment of the present invention, the citrus can be treated with an electrostatically charged spray of the composition including metal antimicrobial agent and poly(hexamethyl biguanide). The composition can be spray applied as charged droplets by using conventional electrostatic spray technologies including inductively charged methodologies. As charged droplets, the composition will be attracted to opposite or differentially charged surfaces such as the surface of the citrus. As a result, more composition can be applied to the citrus and less solution will miss the intended target, commonly called over-spray. The charged droplets can provide an evenly distributed solution layer on the citrus. The charged droplet size can range from about 10 microns to about 500 microns.

Metal and Polymer Antimicrobial Compositions

Suitable antimicrobial compositions are described in U.S. Pat. Nos. 5,817,325, 5,849,311, 5,869,073, 6,030,632, 6,126,931, 6,180,584, 6,264,936, the disclosures of which are incorporated herein by reference for that description. Suitable antimicrobial agents are commercially available from Lonza under the tradename Surfacine. This composition also includes surfactant and alcohol. Suitable compositions include carrier (e.g., water), poly(hexamethyl biguanide), silver ion (e.g. silver iodide), surfactant (e.g., Triton X-100 (octyl phenol alkoxylate n9.5) and Tectronic 1107 (alkoxylated ethylene diamine with, for example an average molecular weight of about 15,000), solvent (e.g., 1-methyl-2-pyrrolidinone), and alcohol (e.g., ethanol). In an embodiment, the composition includes water (e.g., 88 wt-%), poly(hexamethyl biguanide) (e.g., 0.6 wt-%), and silver iodide (e.g., 0.02 wt-%). In this embodiment, the composition can also include Triton X-100 (e.g., 2 wt-% octyl phenol alkoxylate n9.5), Tectronic 1107 (e.g., 1.2 wt-% alkoxylated ethylene diamine with, for example an average molecular weight of about 15,000), 1-methyl-2-pyrrolidinone (e.g., 0.3 wt-%), and ethanol (e.g., 2.8 wt-%).

Suitable polymers include organic materials such as surface active agents, e.g., cationic compounds, polycationic compounds, anionic compounds, polyanionic compounds, non-ionic compounds, polyanionic compounds or zwitterionic compounds. In an embodiment, the polymer includes cationic or polycationic compounds, such as biguanide compounds. Polymeric materials useful in the present invention include benzalkoniumchloride derivatives, such as α-4-[1-tris(2-hydroxyethyl) ammonium-2-butenyl]poly[1-dimethylammonium-2-butenyl]-ω-tris(2-hydroxyethyl) ammonium chloride.

Suitable polymeric compounds include polymeric biguanides and their salts of the general formula: 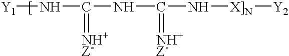
where X is any aliphatic, cycloaliphatic, aromatic, substituted aliphatic, substituted aromatic, heteroaliphatic, heterocyclic, or heteroaromatic compound, or a mixture of any of these, and Y₁ and Y₂ are any aliphatic, cycloaliphatic, aromatic, substituted aliphatic, substituted aromatic, heteroaliphatic, heterocyclic, or heteroaromatic compound, or a mixture of any of these, where n is an integer equal to or greater than 1, and wherein Z is an anion such as Cl⁻ or OH⁻. The polymer can be a free acid form (e.g., not a salt). In an embodiment, the polymeric compound is polyhexamethylene biguanide (available from Zeneca Biocides, Inc. of Wilmington, Del. as a 20% aqueous solution under the trade name COSMOCIL-CQ). Suitable compounds include, e.g., chlorhexidine (available from Aldrich Chemical Co., Milwaukee, Wis.).

The above-mentioned organic materials may be modified to include a thiol group in their structure so as to allow for the bonding of the compound to a metal substrate, or may be derivatized with other functional groups to permit direct immobilization on a non-metallic substrate. For example, the above-mentioned organic materials may be suitably functionalized to incorporate groups such as hydroxy, amine, halogen, epoxy, alkyl or alkoxy silyl functionalities to enable direct immobilization to a surface.

The organic material can be modified with a crosslinking agent to form a modified polymer. Suitable crosslinking agents include, for example, organic multifunctional groups such as isocyanates, epoxides, carboxylic acids, acid chlorides, acid anhydrides, succimidyl ether aldehydes, ketones, alkyl methane sulfones, alkyl trifluoromethane sulfonates, alkyl paratoluene methane sulfones, alkyl halides and organic multifunctional epoxides. The organic material can include a polyhexamethylene biguanide polymer modified with an epoxide, such as N,N-bismethylene diglycidylaniline. The degree of hydrophobicity of the resulting adduct can be adjusted by choice of hydrophobic crosslinking agent. The organic material can be polymeric or non-polymeric. The resulting adduct can be capable of forming a coherent film.

The metal antimicrobial agent can be a metal, metal oxide, metal salt, metal complex, metal alloy or mixture thereof. Examples of metal antimicrobial agents include, e.g., silver, zinc, cadmium, antimony, gold, aluminum, copper, platinum and palladium, their salts, oxides, complexes, and alloys, and mixtures thereof. In an embodiment, the metal antimicrobial is a silver compound, such as a silver halide, e.g., silver iodide. The metal antimicrobial can be introduced into the matrix either contemporaneously with or after application of the organic material to a surface.

Carriers useful in the composition include liquids, gels or foams. Liquids useful as the liquid carrier for the antimicrobial materials include any of a variety of polar liquids, such as water, alcohols such as ethanol or propanol, polar aprotic solvents such as N,N-dimethyl formamide (DMF), dimethyl sulfoxide (DMSO) or N-methyl-2-pyrrolidone (NMP), and mixtures thereof. In an embodiment, the carrier includes ethanol and water.

In the present methods, the amounts and/or concentrations of the materials used will depend upon the nature and stoichiometry of the materials used, and the end product desired. For example, the concentration of the solution, dispersion or suspension of the organic material, or the organic adduct resin formed by the reaction of the polymer and crosslinker, can be about 0.5 to about 20% by weight. For example, the polymer:crosslinker ratio can be about 1:1 to about 3:1 (weight percent).

In an embodiment, the polymeric material is polyhexamethylene biguanide, (PHMB), the crossliking agent is N,N-bismethylenediglycidylaniline (BMDGA), and the silver salt is a silver halide (e.g., silver iodide). In this embodiment, the coating is made by combining a solution of polyhexamethylene biguanide with a solution of the crosslinking agent, and reacting the mixture under conditions sufficient to form a non-crosslinked PHMB-BMDGA adduct. The ratio of PHMB to BMDGA preferably is in the range of from about 1:1 to 3:1 by weight. The PHMB-BMDGA mixture is heated to about 95° C. for about 2 hours in a closed reactor to form the adduct. The concentration of the resulting adduct resin can be about 0.5 to about 20% by weight. The adduct resin solution can be coated onto the desired substrate, and heated to a temperature sufficient to induce crosslinking between the adducts, thereby forming a crosslinked network or matrix. Temperatures sufficient for crosslinking typically are in the range of from about 70° C. to about 200° C. The resulting crosslinked network can be saturated with silver by immersing the coating for about two minutes in a silver iodide/potassium iodide solution. Silver solutions having a concentration of from about 0.005 to about 0.5% can be used for this step.

In an embodiment, the compositions of the present invention include only ingredients that can be employed in food products or in food wash, handling, or processing, for example, according to government (e.g. FDA or USDA) rules and regulations, 21 CFR §170-178. In an embodiment, the compositions of the present invention can include only ingredients at the concentrations approved for incidental food contact by the US EPA, 40 CFR § 180.940.

The present compositions can take the form of a liquid, solid, gel, paste, unit dose, gel pack, or the like. The present compositions can be supplied in any of a variety of containers or media, such as in a 2 compartment dispenser or as a pre-moistened wipe, towelette, or sponge.

Adjuvants

The antimicrobial composition of the invention can also include any number of adjuvants. Specifically, the composition of the invention can include additional antimicrobial agent, wetting agent, defoaming agent, thickener, a surfactant, foaming agent, aesthetic enhancing agent (i.e., colorant (e.g., pigment), odorant, or perfume), among any number of constituents which can be added to the composition. Such adjuvants can be preformulated with the antimicrobial composition of the invention or added to the system simultaneously, or even after, the addition of the antimicrobial composition. The composition of the invention can also contain any number of other constituents as necessitated by the application, which are known and which can facilitate the activity of the present invention.

Additional Antimicrobial Agent

The antimicrobial compositions of the invention can contain an additional antimicrobial agent. Additional antimicrobial agent can be added to use compositions before use. Suitable antimicrobial agents include peroxycarboxylic acid (e.g., medium chain (e.g., C5-C12, C6 to C10, or C8) peroxycarboxylic acid or mixed medium chain and short chain (e.g., C2-C4) peroxycarboxylic acid (e.g., C2 and C8)), carboxylic esters (e.g., p-hydroxy alkyl benzoates and alkyl cinnamates), sulfonic acids (e.g., dodecylbenzene sulfonic acid), iodo-compounds or active halogen compounds (e.g., elemental halogens, halogen oxides (e.g., NaOCl, HOCl, HOBr, ClO₂), iodine, interhalides (e.g., iodine monochloride, iodine dichloride, iodine trichloride, iodine tetrachloride, bromine chloride, iodine monobromide, or iodine dibromide), polyhalides, hypochlorite salts, hypochlorous acid, hypobromite salts, hypobromous acid, chloro- and bromo-hydantoins, chlorine dioxide, and sodium chlorite), organic peroxides including benzoyl peroxide, alkyl benzoyl peroxides, ozone, singlet oxygen generators, and mixtures thereof, phenolic derivatives (e.g., o-phenyl phenol, o-benzyl-p-chlorophenol, tert-amyl phenol and C₁-C₆ alkyl hydroxy benzoates), quaternary ammonium compounds (e.g., alkyldimethylbenzyl ammonium chloride, dialkyldimethyl ammonium chloride and mixtures thereof), and mixtures of such antimicrobial agents, in an amount sufficient to provide the desired degree of microbial protection.

The present composition can include an effective amount of additional antimicrobial agent, such as about 0.001 wt-% to about 60 wt-% antimicrobial agent, about 0.01 wt-% to about 15 wt-% antimicrobial agent, or about 0.08 wt-% to about 2.5 wt-% antimicrobial agent.

Use Compositions

The present compositions include concentrate compositions and use compositions. For example, a concentrate composition can be diluted, for example with water, to form a use composition. In an embodiment, a concentrate composition can be diluted to a use solution before to application to an object. For reasons of economics, the concentrate can be marketed and an end user can dilute the concentrate with water or an aqueous diluent to a use solution.

The level of active components in the concentrate composition is dependent on the intended dilution factor and the desired activity of the medium chain peroxycarboxylic acid compound. Generally, a dilution of about 1 fluid ounce to about 20 gallons of water to about 5 fluid ounces to about 1 gallon of water is used for aqueous antimicrobial compositions. Higher use dilutions can be employed if elevated use temperature (greater than 25° C.) or extended exposure time (greater than 30 seconds) can be employed. In the typical use locus, the concentrate is diluted with a major proportion of water using commonly available tap or service water mixing the materials at a dilution ratio of about 3 to about 20 ounces of concentrate per 100 gallons of water. For example, the use composition can include Surfacine diluted 1:2, 1:4 or 1:8.

For example, a use composition can include about 0.01 to about 4 wt-% of a concentrate composition and about 96 to about 99.99 wt-% diluent; about 0.5 to about 4 wt-% of a concentrate composition and about 96 to about 99.5 wt-% diluent; about 0.5, about 1, about 1.5, about 2, about 2.5, about 3, about 3.5, or about 4 wt-% of a concentrate composition; about 0.01 to about 0.1 wt-% of a concentrate composition; or about 0.01, about 0.02, about 0.03, about 0.04, about 0.05, about 0.06, about 0.07, about 0.08, about 0.09, or about 0.1 wt-% of a concentrate composition. Amounts of an ingredient in a use composition can be calculated from the amounts listed above for concentrate compositions and these dilution factors.

The present invention may be better understood with reference to the following examples. These examples are intended to be representative of specific embodiments of the invention, and are not intended as limiting the scope of the invention.

### EXAMPLES

### Example 1

### The Present Method Reduces Population of Canker Microbes In Vitro and on Plants

The present method was employed against citrus canker microbe in petri dishes and on plants. Effective reduction of citrus canker microbe was seen in each situation.

Materials and Methods

In Vitro Experiments

A thin layer cell culture method was used. Nutritious agar was prepared and put in 9 cm diameter Petri dish. It was solidified and dried. Soft agar (0.6 gr agar+100 ml water) was melted and suspension of citrus canker microbe (Xanthomonas axonopodis pv citri) was added when temperature was moderated. Then the soft agar was poured over the nutritious agar. When it was solid, four holes, each 5 mm in diameter, were made. In those holes were placed the antimicrobial agents. The Petri dishes were then stored for 48 hours at 27° C.

In the first experiment, each antimicrobial composition (obtained as a stock solution) was diluted to 0.1 vol-% (Table 1).

In a second experiment bacteria suspension used was Xanthomonas axonopodis pv citri, D.O.:0.523 600 nm. Products to be tested were the same as in the first experiment, but at different doses (Table 2). Each of the three antimicrobial compositions obtained as a stock solution was diluted to 0.2 vol-%. The metal antimicrobial agent and poly(hexamethyl biguanide) composition was used as the neat (undiluted) stock solution (Composition B).

Nursery Experiment

In a nursery experiment, three antimicrobial compositions and a control composition were tested for activity against citrus canker microbe. The compositions were sprayed on fruit bearing citrus trees that had been inoculated with citrus canker microbe (Xanthomonas axonopodis pv citri). In these experiments composition A was the metal antimicrobial agent and poly(hexamethyl biguanide) composition and composition B was this composition plus copper ion.

The composition of metal antimicrobial agent and poly(hexamethyl biguanide) as used in compositions A and B included: water (88 wt-%), poly(hexamethyl biguanide) (0.6 wt-%), and silver iodide (0.02 wt-%) Triton X-100 (2 wt-%), Tectronic 1107 (1.2 wt-%), 1-methyl-2-pyrrolidinone (0.3 wt-%), and ethanol (2.8 wt-%).

Results

In Vitro Experiments

TABLE 1

| Product | Inhibition Halo |
|---|---|
| Triquart B | 5.5 mm |
| Composition A | 0 |
| Composition B | 0 |
| Mixed Peracid | 3.1 mm |

Only Triquart and Mixed Peracid showed detectable antimicrobial activity.

TABLE 2

| Product and Doses | Inhibition Halo | |
|---|---|---|
| Triquart B | 2.3 | mm |
| Composition A | 0 | |
| Composition B | 7.45 | mm |
| Mixed Peracid | 3 | mm |

Three of the products (Triquart, composition of metal antimicrobial agent and poly(hexamethyl biguanide), and Mixed Peracid) inhibited growth of Xanthomonas axonopodis pv citri.

Nursery Experiments

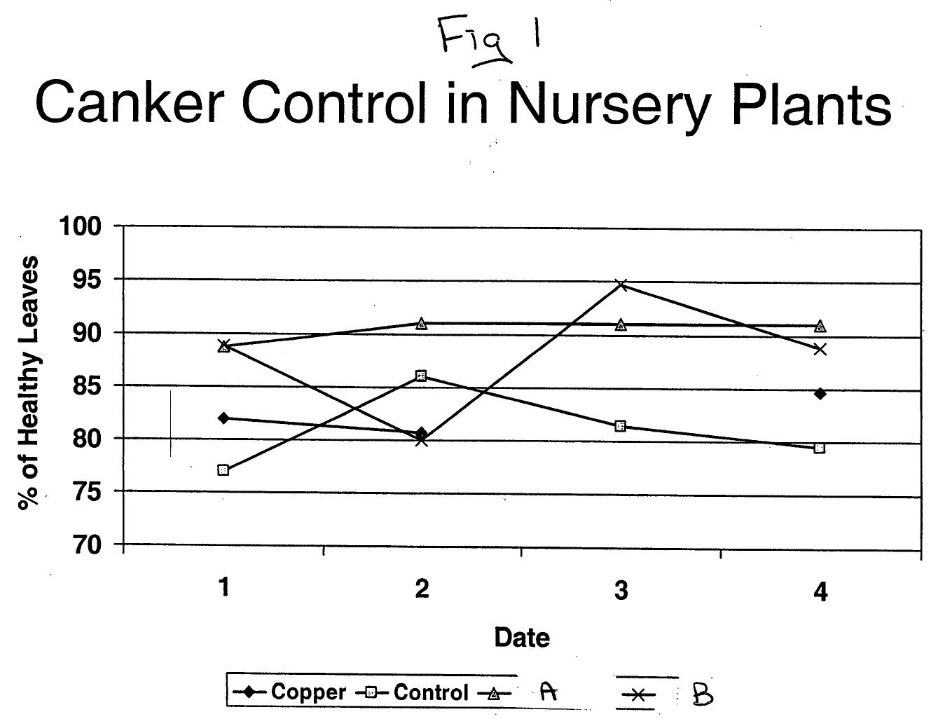

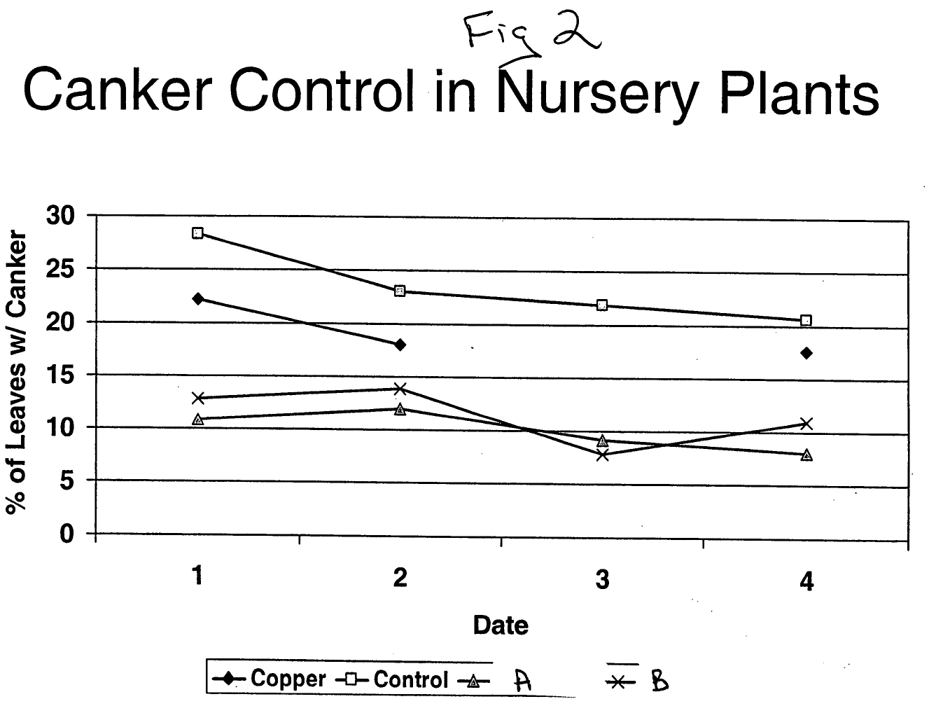

The results of tests of the present method against citrus canker microbe in a nursery on plants are reported in Table 3 and FIGS. 1 and 2. The antimicrobial composition was applied periodically and the plants were challenged with citrus canker microbe. The present method (compositions A and B) was effective in reducing the population of citrus canker microbe, as evidenced by an increase in the number of healthy leaves and a decrease in the number of leaves with canker.

TABLE 3

| | | | | |
|---|---|---|---|---|
| Treatment | Date 1 | Date 2 | Date 3 | Date 4 |

% OF HEALTHY LEAVES

| | | | | |
|---|---|---|---|---|
| Copper | 82 | 80.7 | | 84.7 |
| Control | 77 | 86 | 81.5 | 79.5 |
| A | 88.8 | 91 | 91 | 91 |
| B | 88.9 | 80 | 94.7 | 88.9 |

% OF LEAVES WITH CANKER

| | | | | |
|---|---|---|---|---|
| Copper | 22.2 | 18 | | 17.59 |
| Control | 28.3 | 23 | 21.9 | 20.6 |
| A | 10.8 | 12.02 | 9.2 | 8 |
| B | 12.8 | 13.9 | 7.8 | 10.9 |

### Example 2

### The Present Method Provides Persistent Reduction of Microbe Population on Plants

The present method produced greater long term efficacy compared to a control composition.

Materials and Methods

The antimicrobial agent was Composition A as described in Example 1 (Surfacine®, commercially available from Lonza). The control composition was biguanide (0.6 wt-%).

The compositions were applied indoors to three small orange trees. 10 leaves on each tree were marked for control and test treatments. The test or control composition was applied to each marked leaf. The marked leaves were misted with water weekly through testing.

At the start of the test, after two weeks, and after 6 weeks, two leaves off of each tree were sampled. The sample leaf was cut off the tree, inoculated with 0.1 ml of a 10⁵ CFU/ml culture of Pseudomonas aeruginosa ATCC 15442, and allowed to dry for one hour. Each sample leaf was then placed into a stomacher bag containing the appropriate neutralizer and stomached for 30 seconds. The liquid from the stomacher bag was serially diluted and plated onto Tryptone Glucose Extract Agar. Plates will be incubated at 35° C. for 48 hours. Colony forming units were determined and reported in Table 4, below.

Results

As shown in Table 4, the Surfacine® composition remained on the leaves and caused a greater reduction in microbes after two weeks of exposure to atmosphere and misting compared to the biguanide control.

| | Log CFU | Biguanide | Surfacine |
|---|---|---|---|
| | Applied to Leaf | Log Reduction | Log Reduction |
| Initial | 4.7 | 4.7 | >4.7 |
| 2 weeks | 4.7 | 3.2 | 4.0 |
| 6 weeks | 4.7 | 0.7 | 0.8 |

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

All publications and patent applications in this specification are indicative of the level of ordinary skill in the art to which this invention pertains.

The invention has been described with reference to various specific and preferred embodiments and techniques. However, it should be understood that many variations and modifications may be made while remaining within the spirit and scope of the invention.

We claim:

1. A method of reducing population of canker microbe on an object, the method comprising:
applying to the object an antimicrobial composition comprising metal antimicrobial agent, poly(hexamethyl biguanide), surfactant, and alcohol in amount and for time sufficient to reduce the microbial population.

2. The method of claim 1, wherein the antimicrobial composition comprises silver ion, octyl phenol alkoxylate n9.5, alkoxylated ethylene diamine, and ethanol; and
further comprises carrier and solvent.

3. The method of claim 2, wherein the antimicrobial composition comprises silver iodide, alkoxylated ethylene diamine of average molecular weight of about 15,000, carrier comprising water, and solvent comprising 1-methyl-2-pyrrolidinone.

2. The method of claim 1, wherein applying comprises applying the antimicrobial composition to citrus tree.

3. The method of claim 1, wherein applying comprises applying the antimicrobial composition to citrus fruit.

4. The method of claim 3, wherein the citrus fruit is on a citrus tree.

5. The method of claim 3, wherein the citrus fruit is off a citrus tree.

6. The method of claim 1, wherein applying comprises applying the antimicrobial composition to equipment used in a citrus orchard.

7. The method of claim 1, wherein applying comprises applying the antimicrobial composition to equipment used for transport or processing citrus fruit.

8. The method of claim 1, wherein applying comprises applying the antimicrobial composition to equipment used for transport or processing citrus plant.

9. The method of claim 1, comprising reducing the population of Xanthomonas axonopodis pv. citri.

10. The method of claim 1, wherein the composition comprises silver.

11. The method of claim 1, wherein the composition further comprises surfactant and alcohol.

12. A method of treating citrus canker comprising:
applying to citrus tree an antimicrobial composition comprising metal antimicrobial agent, poly(hexamethyl biguanide), surfactant, and alcohol in amount and for time sufficient to prevent or cure citrus canker.

13. A composition for reducing the population of canker microbe, the composition comprising:
metal antimicrobial agent, poly(hexamethyl biguanide), surfactant, and alcohol;
the composition being configured for applying to an object subject to contamination with canker microbe.

14. An article of manufacture comprising:
a sprayer configured for spraying citrus; and
composition comprising metal antimicrobial agent, poly(hexamethyl biguanide), surfactant, and alcohol.

15. An article of manufacture comprising:
composition comprising metal antimicrobial agent, poly(hexamethyl biguanide), surfactant, and alcohol; and
instructions for applying the composition to citrus.

16. An article of manufacture comprising:
composition comprising metal antimicrobial agent, poly(hexamethyl biguanide), surfactant, and alcohol; and
instructions for applying the composition to object subject to contamination with canker microbe.
